(19) United States
(12) Patent Application Publication
(10) Pub. No.: US 2024/0292309 A1
(43) Pub. Date: Aug. 29, 2024

(54) METHOD FOR UE COMMUNICATION PATH SWITCH BASED ON POLICY

(71) Applicant: ZTE CORPORATION, Shenzhen (CN)

(72) Inventor: Hao DONG, Shenzhen (CN)

(73) Assignee: ZTE CORPORATION, Shenzhen (CN)

(21) Appl. No.: 18/431,004

(22) Filed: Feb. 2, 2024

Related U.S. Application Data
(63) Continuation of application No. PCT/CN2021/122646, filed on Oct. 8, 2021.

(51) Int. Cl. H04W 40/12; H04W 40/34; H04W 92/18

(52) U.S. Cl. CPC H04W 40/12; H04W 40/34; H04W 92/18

(57) ABSTRACT

A wireless communication method for use in a first wireless terminal is disclosed. The method comprises communicating with a second wireless terminal for a proximity service on a first communication path, and checking a communication path policy after a communication path quality fails to satisfy at least one communication requirement of the proximity service, to determine whether to switch to a second communication path for the proximity service, wherein the first communication path is one of a direct communication path between the first wireless terminal and the second wireless terminal and an indirect communication path which involves a network and is between the first wireless terminal and the second wireless terminal, and the second communication path is another one of the direct communication path and the indirect communication path.

### CROSS-REFERENCE TO RELATED PATENT APPLICATIONS

This application is a Continuation of PCT Application No. PCT/CN2021/122646, filed Oct. 8, 2021, incorporated herein by reference in its entirety.

### TECHNICAL FIELD

This document is generally directed to wireless communications.

### BACKGROUND

In a 3^{rd} generation partner project (3GPP) system, two user equipments UEs may communicate with each other through a network (i.e., via a Uu interface). That is, a communication path between these two UEs includes a Radio Access Network (node) and a Core Network. When one UE is in proximity of another UE, these two UEs may be able to communicate to each other directly. Proximity Service (ProSe) Communication enables establishments of new communication paths via a PC5 interface between two or more ProSe-enabled UEs that are in communication range. For the wireless communications, the ProSe service is expected to be an important system wide enabler to support various applications and services such as those in commercial and public safety domains.

### SUMMARY

According to the above, for communications between two UEs, there are two different paths which could be used: a Uu communication path (via Radio Access Network and Core Network) and a PC5 communication path (UEs exchange data directly). When two UEs communicate with each other through one of these paths (i.e., direct PC5 communication path or indirect Uu communication path) and a communication path quality on this path becomes worse, one of the UEs may decide to switch the communication path from the direct PC5 path to the indirect Uu path or vice versa. However, conditions triggering the path switching between the PC5 path and the indirect Uu path are unclear. Furthermore, how the UE switches the communication path between the direct PC5 path and the indirect Uu path are also unknown.

This document relates to methods, systems, and devices for switching a communication path of a wireless terminal, and more particularly to methods, systems, and devices for switching a communication path of a wireless terminal based on a policy.

The present disclosure relates to a wireless communication method for use in a first wireless terminal. The method comprises:
communicating with a second wireless terminal for a proximity service on a first communication path, and
checking a communication path policy after a communication path quality fails to satisfy at least one communication requirement of the proximity service, to determine whether to switch to a second communication path for the proximity service,
wherein the first communication path is one of a direct communication path between the first wireless terminal and the second wireless terminal and an indirect communication path which involves a network and is between the first wireless terminal and the second wireless terminal, and the second communication path is another one of the direct communication path and the indirect communication path.

Various embodiments may preferably implement the following features:

Preferably or in some embodiments, the communication path policy comprises a mapping from at least one proximity service to at least one of the first communication path or the second communication path.

Preferably or in some embodiments, the communication path policy indicates that the proximity service supports the second communication path, and checking the communication path policy for the proximity service, to determine whether to switch the proximity service to the second communication path comprises:
switching the proximity service to the second communication path.

Preferably or in some embodiments, the communication path policy indicates that the proximity service supports only the first communication path, and checking the communication path policy for the proximity service, to determine whether to switch the proximity service to the second communication path comprises at least one of:
terminating the proximity service, or
downgrading a service quality of the proximity service.

Preferably or in some embodiments, the direct communication path is a PC5 communication path and the indirect communication path is a Uu communication path.

Preferably or in some embodiments, the at least one communication requirement of the proximity service comprises at least one quality of service parameter of the proximity service.

Preferably or in some embodiments, the communication path quality fails to satisfy the at least one communication requirement if at least one quality of service parameter of the proximity service has become lower than the threshold associated with the proximity service.

Preferably or in some embodiments, the at least one quality of service parameter comprises at least one of a packet delay budget or a packet error rate.

Preferably or in some embodiments, the threshold is preconfigured or is a parameter received from a policy control function.

Preferably or in some embodiments, the wireless communication method further comprises receiving, from a wireless network node, the communication path policy no later than registering to the network through the wireless network node.

The present disclosure relates to a wireless communication method for use in a wireless network node. The method comprises transmitting, to a wireless terminal, a communication path policy no later than that the wireless terminal registering to a network through the wireless network node,
wherein the communication path policy is associated with a path switching between a first communication path and a second communication path for at least one proximity service,
wherein the first communication path is one of a direct communication path between the first wireless terminal and the second wireless terminal and an indirect communication path which involves the network and is between the first wireless terminal and the second wireless terminal, and the second communication path is another one of the direct communication path and the indirect communication path.

Various embodiments may preferably implement the following features:

Preferably or in some embodiments, the direct communication path is a PC5 communication path and the indirect communication path is a Uu communication path.

Preferably or in some embodiments, the communication path policy comprises a mapping from at least one proximity service to at least one of the first communication path or the second communication path.

Preferably or in some embodiments, the communication path policy indicates whether each of the at least one proximity service supports at least one of the first communication path or the second communication path.

The present disclosure relates to a first wireless terminal. The first wireless terminal comprises:
a communication unit, configured to communicate with a second wireless terminal for a proximity service on a first communication path, and
a processor configured to check a communication path policy after a communication path quality fails to satisfy at least one communication requirement of the proximity service, to determine whether to switch to a second communication path for the proximity service.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to transmit, to a wireless terminal, a communication path policy no later than that the wireless terminal registering to a network through the wireless network node.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a communication system according to an embodiment of the present disclosure.

FIG. 2 shows a schematic diagram of a procedure for path switch according to an embodiment of the present disclosure.

FIG. 3 shows a schematic diagram of a procedure for path switch according to an embodiment of the present disclosure.

FIG. 4 shows a schematic diagram of a procedure for path switch according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 shows a flowchart of a method according to an embodiment of the present disclosure.

FIG. 8 shows a flowchart of a method according to an embodiment of the present disclosure.

### DETAILED DESCRIPTION

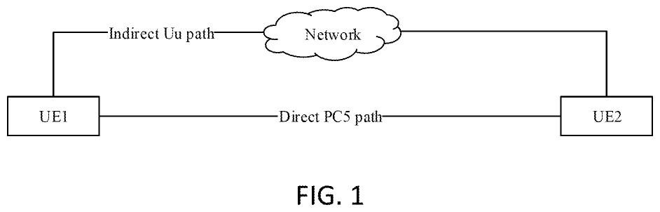

FIG. 1 shows a schematic diagram of a communication system according to an embodiment of the present disclosure. In FIG. 1, two UEs UE1 and UE2 communicate with each other via a direct PC5 (communication) path or an indirect Uu (communication) path (i.e., through the network). In an embodiment, the network comprises a radio access network (node) (RAN (node)) and a core network (CN). Note that the network may further comprise other network entities/functions/components such as an access and mobility management function (AMF), a session management function (SMF), an application function (AF), a user plane function (UPF), a policy control function (PCF), . . . , etc.

In an embodiment, the UE1 and UE2 may be served by different RAN nodes (e.g., base stations) and/or different CNs.

In an embodiment, when the UE1 and UE2 communicates with each other through one of the PC5 path and the Uu path and the communication quality on the used path becomes worse, one of the UE1 and UE2 may need to switch the communication path to another one of the PC5 path and the Uu path. In such a scenario, conditions of triggering the path switching and how the UE switches the communication path between two UEs from direct PC5 path to indirect Uu path or vice versa need to be discussed.

In an embodiment, the UE1 exchanges data for a ProSe service with the UE2 through a first communication path, wherein the first communication path is one of the direct PC5 path and the indirect Uu path and another one of the direct PC5 path and the indirect Uu path is called second communication path. When a communication quality of the first communication path cannot satisfy requirements of the communication between these two UEs (e.g., the requirements of the ProSe service), the UE checks a communication path policy to determine (e.g., figure out) whether the served ProSe service can use the second communication path for the communications. For example, the communication quality of the first communication path cannot satisfy requirements of the communication when the (quantized) communication quality has become lower than a path quality threshold. If the ProSe service is able to use the second communication path, the UE establishes the second communication path if the second communication path does not exist or modifies the existing second communication path to accommodate the ProSe service. Next, the data exchange for the ProSe service is based on the newly switched path.

In an embodiment, whether a communication path is suitable for the ProSe service depends on a service type of the ProSe service. For example, an interactive gaming service requiring cloud computing needs to be bound to the Uu communication path. In comparison, a chatting application used in a party may select the PC5 communication path. Therefore, in an embodiment, the communication path policy regarding whether communication path(s) is suitable for a ProSe service may be included in the service authorization provisioning policy/parameter to the UE. For instance, the communication path policy may include a mapping between service types/services to the communication path(s) (i.e., PC5 path and/or Uu path). In an embodiment, one service/service type may be mapped to only the PC5 path (i.e., the service uses only PC5 path), to only the Uu path (i.e., the service uses only Uu path) or to both the PC5 path and the Uu path (i.e., the service uses both the PC5 path and the Uu path).

In an embodiment, requirements of the communication quality may be evaluated as QoS parameters which are used for this communication (e.g., ProSe service). The quality of the communication path could be measured by one or more QoS parameters, such as packet delay budget (PDB), and packet error rate (PER).

In an embodiment, the path quality threshold associated with determining whether the communication quality satisfies the requirements of communication or ProSe service may be the minimum value(s) of the QoS parameter(s) which satisfy the quality requirements of the communication.

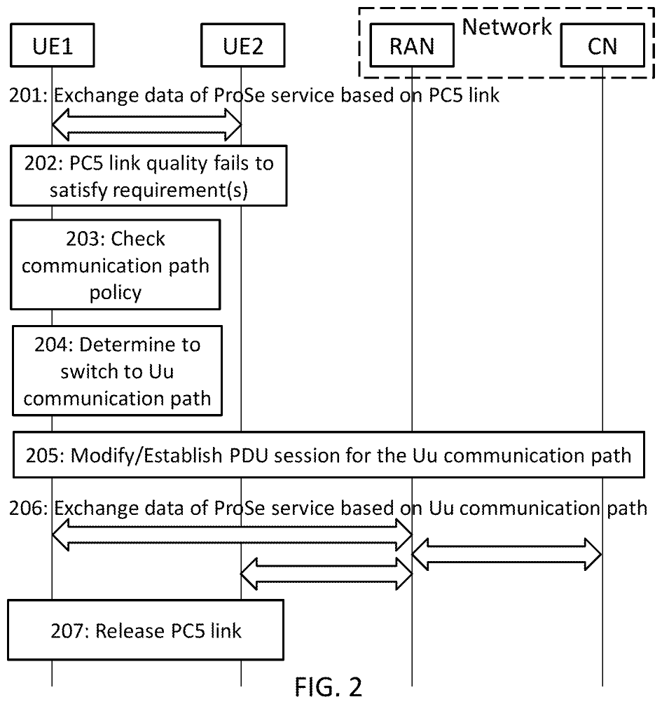

FIG. 2 shows a schematic diagram of a procedure for path switch according to an embodiment of the present disclosure. In FIG. 2, the communication path between two UEs (i.e., UE1 and UE2) is switched from the PC5 path to the Uu path. Specifically, the procedure shown in FIG. 2 comprises the following steps:

Step 201: The UE1 and the UE2 exchange data of a ProSe service based on the PC5 link (i.e., PC5 communication path) between these two UEs.

Step 202: The quality of the PC5 link between the UE1 and the UE2 downgrades and has become lower than a threshold.

In an embodiment, the threshold could be preconfigured in the UE or provisioned as a parameter by PCF when the UE registers to the network.

Step 203: UE1 checks the communication path policy to determine whether the ProSe service supports Uu communication path.

The communication path policy is provisioned to the UE1 when (or no earlier than) the UE1 registers to the network. In an embodiment, the communication path policy includes the mapping of the ProSe service to the PC5 path and/or the Uu path. For example, the ProSe service may be mapped to:
only the PC5 path shall be used,
only the Uu path shall be used, or
both PC5 path and Uu path could be used.

In this embodiment, the UE1 confirms that the ProSe service could use the Uu communication path based on the communication path policy.

Step 204: The UE1 decides to switch the communication path for this ProSe service from the PC5 path to the Uu path.

Step 205: The UE1 establishes a PDU session as the Uu communication path if the PDU session does not exist. As an alternative, the UE1 modifies the existed PDU session to accommodate the ProSe service in the Uu communication path.

Step 206: The UE1 and UE2 exchange data for the ProSe service based on the Uu path through the network, i.e., through the RAN and the CN serving the UE1 and the UE2. Step 207: The UE1 releases the PC5 link with the UE2.

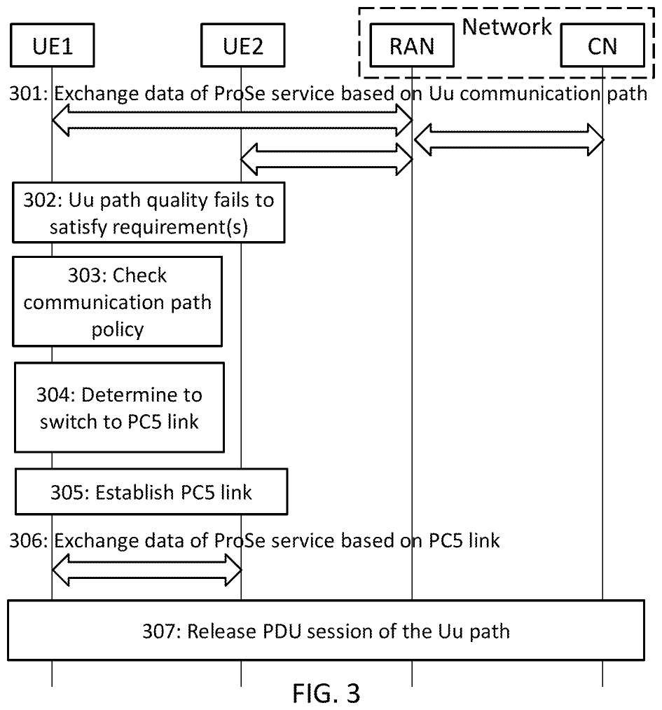

FIG. 3 shows a schematic diagram of a procedure for path switch according to an embodiment of the present disclosure. In FIG. 3, the communication path between two UEs (i.e., UE1 and UE2) is switched from the Uu path to the PC5 path. Specifically, the procedure shown in FIG. 3 comprises the following steps:

Step 301: The UE1 and UE2 exchange data of a ProSe service based on the Uu communication path through the network, which includes the RAN and the CN serving the UE1 and the UE2.

Step 302: The communication quality of the Uu path has become lower than a threshold. The threshold may be preconfigured in the UE or provisioned as a parameter by the network (e.g., PCF) when the UE registers to the network.

Step 303: The UE1 checks the communication path policy to find whether the ProSe service supports the direct PC5 communication path. In this embodiment, the UE1 confirms that the ProSe service could use PC5 communication path based on the communication path policy.

Step 304: The UE1 decides to switch the communication for this ProSe service from the Uu path to the PC5 path.

Step 305: The UE1 establishes a PC5 link as the direct communication path (i.e., PC5 communication path) if the PC5 link does not exist. If the PC5 link between the UE1 and the UE2 has been established, the UE1 modifies the existed PC5 link to accommodate the ProSe service in this PC5 link.

Step 306: The UE1 and the UE2 exchange data for the ProSe service based on the PC5 link between these two UEs directly.

Step 307: The UE1 releases the PDU session of the indirect Uu path if the Uu path is not used for other purposes.

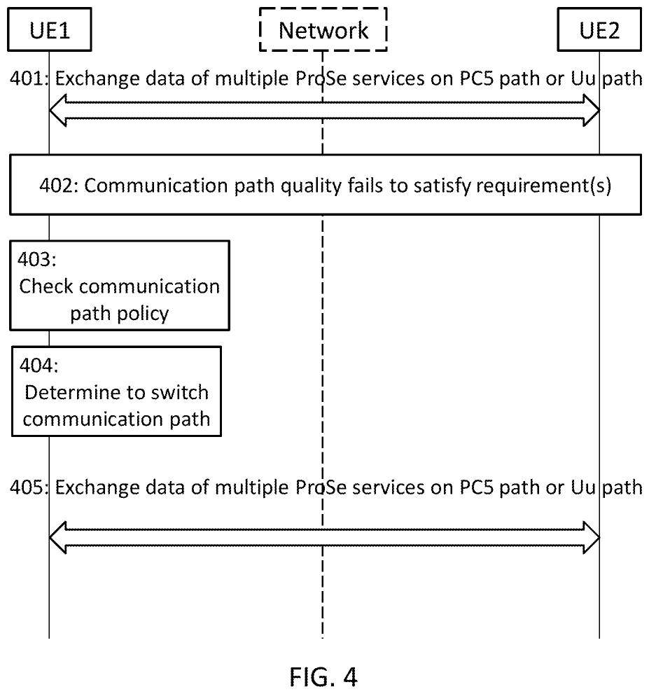

FIG. 4 shows a schematic diagram of a procedure for handling path switches of multiple ProSe services according to an embodiment of the present disclosure. Specifically, the procedure shown in FIG. 4 comprises the following steps:

Step 401: The UE1 and the UE2 exchange data for multiple ProSe services on either the direct PC5 path or the indirect Uu path.

For the communications on the direct PC5 path, the service data is exchanged between UE1 and UE2 without involving the network.

For the communication on the indirect Uu path, the service data is exchanged between UE1 and UE2 through the network.

Step 402: The communication path qualities for ProSe services are getting worse and have become lower than the thresholds for the ProSe services. Note that different ProSe services may have the same or different thresholds (for path switching).

Step 403: The UE1 checks the communication path policy to find whether the ProSe services whose communication qualities have become lower than the corresponding threshold support another communication path. In this embodiment, at least one of the ProSe services, whose communication qualities have become lower than the corresponding threshold, supports another communication path based on the communication path policy.

Step 404: The UE1 decides to switch the communication path for these ProSe service to another path.

Step 405: The UE1 and UE2 exchange data for these ProSe services on another communication path. The communication path is either the indirect Uu path communication through the network or the direct PC5 path communication without involving the network.

In an embodiment, if the communication quality of a ProSe service has become lower than the corresponding threshold and the communication path policy indicates that this ProSe service cannot use another communication path, the UE1 may either terminate the ProSe service with UE2 or degrade the communication quality for this ProSe service (still using the original communication path).

In an embodiment, one UE exchanges data for the ProSe service with another UE through one of the paths: either direct PC5 path or indirect Uu path. When the quality of the used communication path is getting worse and cannot satisfy the requirements of the communications between these two UEs, the UE checks the communication path policy to determine whether the served ProSe service can use another path for the communication. If the ProSe service can use another communication path, the UE establishes another communication path if it does not exist; or modify the existed communication path to accommodate the ProSe service. The data exchange for this ProSe service changes to be based on another communication path.

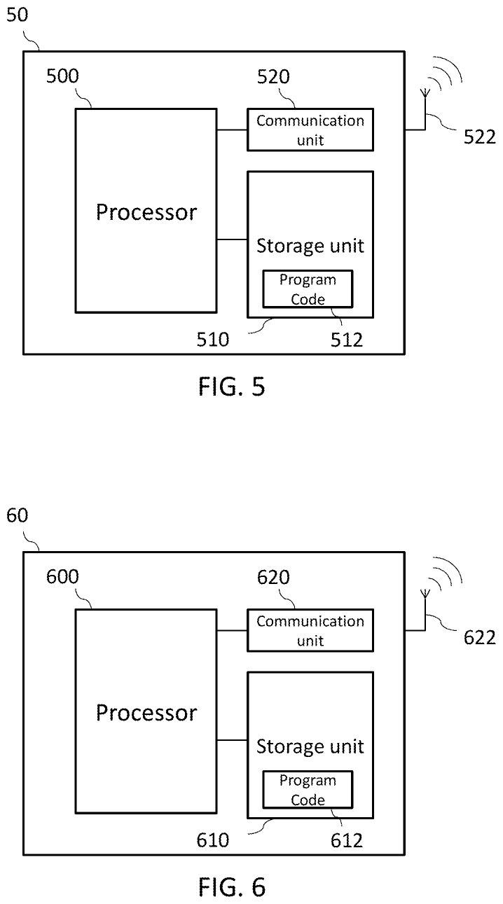

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g., a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment or another wireless network node).

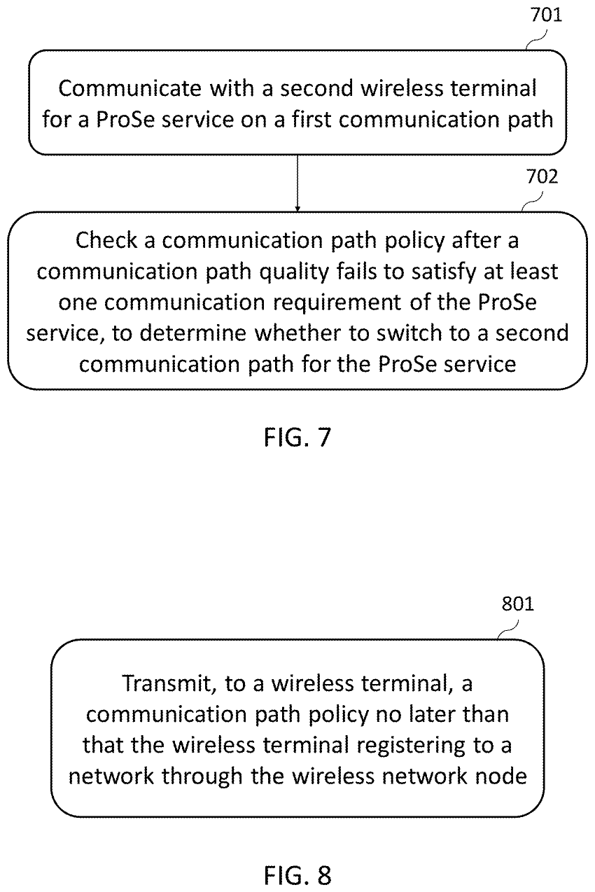

FIG. 7 shows a flow chart of a method according to an embodiment of the present disclosure. The method shown in FIG. 7 may be used in a first wireless terminal (e.g., UE1) and comprises the following steps:

Step 701: Communicate with a second wireless terminal for a ProSe service on a first communication path.

Step 702: Checking a communication path policy after a communication path quality fails to satisfy at least one communication requirement of the ProSe service, to determine whether to switch to a second communication path for the ProSe service.

In FIG. 7, the first wireless terminal communicates with a second wireless terminal (e.g., UE2) for a ProSe service on a first communication path. After a communication path quality (for the ProSe service) fails to satisfy at least one communication requirement of the ProSe service, the first wireless terminal checks a communication path policy to determine whether to switch to a second communication path for the ProSe service. In this embodiment, the first communication path is one of a direct communication path between the first wireless terminal and the second wireless terminal (e.g., PC5 communication path) and an indirect communication path which involves a network and is between the first wireless terminal and the second wireless terminal (e.g. Uu communication path), and the second communication path is another one of the direct communication path and the indirect communication path.

In an embodiment, the communication path policy comprises a mapping from at least one ProSe service to at least one of the first communication path or the second communication path. For example, in the mapping of the communication path policy, each ProSe service may be mapped to:
only the first communication path,
only the second communication path, or
both the first communication path and the second communication path.

In an embodiment, the communication path policy indicates that the ProSe service supports the second communication path. For example, the mapping in the communication path policy indicates that the ProSe service is mapped to both the first communication path and the second communication path. In this embodiment, the first wireless terminal switches the ProSe service to the second communication path.

In an embodiment, the communication path policy indicates that the ProSe service supports only the first communication path. That is, the communication path policy indicates that the ProSe service does not support the second communication path. Under such a condition, the first wireless terminal may terminate the ProSe service and/or downgrade a service quality (e.g., resolution of videos/images, sampling rate of sound signal, . . . , etc.) of the ProSe service.

In an embodiment, the at least one communication requirement of the ProSe service comprises at least one QoS parameter of the ProSe service.

In an embodiment, the communication path quality fails to satisfy the at least one communication requirement if at least one QoS parameter of the ProSe service has become lower than the threshold associated with the ProSe service.

In an embodiment, the at least one QoS parameter comprises at least one of a packet delay budget or a packet error rate.

In an embodiment, the threshold is preconfigured or is a parameter received from a PCF.

In an embodiment, the first wireless terminal may receive the communication path policy from a wireless network node (e.g., RAN node) no later than (when and/or after) registering to the network through the wireless network node.

FIG. 8 shows a flowchart of a method according to an embodiment of the present disclosure. The method shown in FIG. 8 may be used in a wireless network node (e.g., RAN node or gNB) and comprises the following step:

Step 801: Transmit, to a wireless terminal, a communication path policy no later than that the wireless terminal registering to a network through the wireless network node.

In FIG. 8, the wireless network node transmits a communication path policy to a wireless terminal (e.g., UE) no later than (e.g., when and/or after) the wireless terminal register to a network through the wireless network node. The communication path policy is associated with a path switching between a first communication path and a second communication path for at least one ProSe service. Note that the first communication path is one of a direct communication path between the first wireless terminal and the second wireless terminal (e.g., PC5 communication path) and an indirect communication path which involves the network and is between the first wireless terminal and the second wireless terminal (e.g., Uu communication path), and the second communication path is another one of the direct communication path and the indirect communication path.

In an embodiment, the communication path policy comprises a mapping from at least one ProSe service to at least one of the first communication path or the second communication path.

For example, in the mapping of the communication path policy, each ProSe service may be mapped to:
only the first communication path,
only the second communication path, or
both the first communication path and the second communication path.

In an embodiment, the communication path policy indicates whether each of the at least one ProSe service supports at least one of the first communication path or the second communication path.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a first wireless terminal, the wireless communication method comprising:
communicating with a second wireless terminal for a proximity service on a first communication path, and
checking a communication path policy after a communication path quality fails to satisfy at least one communication requirement of the proximity service, to determine whether to switch to a second communication path for the proximity service,
wherein the first communication path is one of a direct communication path between the first wireless terminal and the second wireless terminal and an indirect communication path which involves a network and is between the first wireless terminal and the second wireless terminal, and the second communication path is another one of the direct communication path and the indirect communication path.

2. The wireless communication method of claim 1, wherein the communication path policy comprises a mapping from at least one proximity service to at least one of the first communication path or the second communication path.

3. The wireless communication method of claim 1, wherein the communication path policy indicates that the proximity service supports the second communication path, and wherein checking the communication path policy for the proximity service, to determine
whether to switch the proximity service to the second communication path comprises:
switching the proximity service to the second communication path.

4. The wireless communication method of claim 1, wherein the communication path policy indicates that the proximity service supports only the first communication path, and wherein checking the communication path policy for the proximity service, to determine
whether to switch the proximity service to the second communication path comprises at least one of:
terminating the proximity service, or
downgrading a service quality of the proximity service.

5. The wireless communication method of claim 1, wherein the direct communication path is a PC5 communication path and the indirect communication path is a Uu communication path.

6. The wireless communication method of claim 1, wherein the at least one communication requirement of the proximity service comprises at least one quality of service parameter of the proximity service.

7. The wireless communication method of claim 1, wherein the communication path quality fails to satisfy the at least one communication requirement if at least one quality of service parameter of the proximity service has become lower than the threshold associated with the proximity service.

8. The wireless communication method of claim 6, wherein the at least one quality of service parameter comprises at least one of a packet delay budget or a packet error rate.

9. The wireless communication method of claim 7, wherein the threshold is preconfigured or is a parameter received from a policy control function.

10. The wireless communication method of claim 1, further comprising:
receiving, from a wireless network node, the communication path policy no later than registering to the network through the wireless network node.

11. A wireless communication method for use in a wireless network node, the wireless communication method comprising:
transmitting, to a wireless terminal, a communication path policy no later than that the wireless terminal registering to a network through the wireless network node,
wherein the communication path policy is associated with a path switching between a first communication path and a second communication path for at least one proximity service,
wherein the first communication path is one of a direct communication path between the first wireless terminal and the second wireless terminal and an indirect communication path which involves the network and is between the first wireless terminal and the second wireless terminal, and the second communication path is another one of the direct communication path and the indirect communication path.

12. The wireless communication method of claim 11, wherein the direct communication path is a PC5 communication path and the indirect communication path is a Uu communication path.

13. The wireless communication method of claim 11, wherein the communication path policy comprises a mapping from at least one proximity service to at least one of the first communication path or the second communication path.

14. The wireless communication method of claim 11, wherein the communication path policy indicates whether each of the at least one proximity service supports at least one of the first communication path or the second communication path.

15. A first wireless terminal, comprising:
a communication unit, configured to communicate with a second wireless terminal for a proximity service on a first communication path, and
a processor configured to check a communication path policy after a communication path quality fails to satisfy at least one communication requirement of the proximity service, to determine whether to switch to a second communication path for the proximity service,
wherein the first communication path is one of a direct communication path between the first wireless terminal and the second wireless terminal and an indirect communication path which involves a network and is between the first wireless terminal and the second wireless terminal, and the second communication path is another one of the direct communication path and the indirect communication path.

16. A wireless network node, comprising:
a communication unit, configured to transmit, to a wireless terminal, a communication path policy no later than that the wireless terminal registering to a network through the wireless network node,
wherein the communication path policy is associated with a path switching between a first communication path and a second communication path for at least one proximity service,
wherein the first communication path is one of a direct communication path between the first wireless terminal and the second wireless terminal and an indirect communication path which involves the network and is between the first wireless terminal and the second wireless terminal, and the second communication path is another one of the direct communication path and the indirect communication path.

17. A non-transitory computer-readable program medium having code stored thereupon, the code, when executed by at least one processor, causes the at least one processor to implement a wireless communication method recited in claim 1.

18. A non-transitory computer-readable program medium having code stored thereupon, the code, when executed by at least one processor, causes the at least one processor to implement a wireless communication method recited in claim 2.

19. A non-transitory computer-readable program medium having code stored thereupon, the code, when executed by at least one processor, causes the at least one processor to implement a wireless communication method recited in claim 11.

20. A non-transitory computer-readable program medium having code stored thereupon, the code, when executed by at least one processor, causes the at least one processor to implement a wireless communication method recited in claim 12.
